(19) United States
(12) Patent Application Publication
(10) Pub. No.: US 2018/0147836 A1
(43) Pub. Date: May 31, 2018

(54) METHOD FOR IMPROVING INKJET PRINT QUALITY

(71) Applicant: Océ Holding B.V., Venlo (NL)

(72) Inventor: Pierre A.M. KLERKEN, Venlo (NL)

(73) Assignee: Océ Holding B.V., Venlo (NL)

(21) Appl. No.: 15/821,419

(22) Filed: Nov. 22, 2017

(30) Foreign Application Priority Data
Nov. 30, 2016 (EP) 16201367.6

(51) Int. Cl. B41J 2/045

(52) U.S. Cl. CPC B41J 2/04525; B41J 2/04573; B41J 2/04581

(57) ABSTRACT

A method is disclosed for applying marking material to a substrate, thereby reproducing an image. At least two arrays and at least two piezo-electric print elements in each array are used. An actuation signal for a print element is applied with a predetermined delay with respect to a reference actuation signal. The predetermined delay values are based on a measurement of a drop velocity in dependence on a further, simultaneous actuation of a neighboring print element. They form a repetitive series of delay values for reducing an amount of mechanical crosstalk between the print elements in an array. Two print elements that produce a drop of marking material for landing in each others vicinity on the substrate are associated with a different delay value of the repetitive series.

### BACKGROUND OF THE INVENTION

### 1. Field of the Invention

The invention relates to a method for applying marking material to a substrate in order to reproduce an image by at least two arrays of at least two print elements in each array, a print element comprising a piezo-electric actuation element for generating a drop of marking material, an actuation signal for a print element being applied with a predetermined delay with respect to a reference actuation signal. The invention further relates to a print system for applying marking material to a substrate in order to reproduce an image.

### 2. Description of the Related Art

Print systems are known for applying marking material to a substrate in order to reproduce an image using arrays of print elements, a print element comprising a piezo-electric actuation element for generating a drop of marking material. The marking material is often called ink, but may also be a different liquid, either or not at an elevated temperature. The piezo-electric actuation element is an electromechanical transducer converting an electric actuation signal into a mechanical displacement and is placed in the print element such that the mechanical displacement results in a drop generation. These print systems are known as piezo-electric inkjet systems.

It is also known that in an array of print elements mechanical or acoustic crosstalk occurs. This means that the generation process of a drop in one print element is influenced by a status of a directly or further neighboring print element. If that neighboring print element is simultaneously actuated to generate a drop, the two processes influence each other and the drops have different size and/or velocity than in the case of a single print element activation without activation of a neighboring print element. A deviant drop size leads to a deviant dot size in an image and a deviant velocity leads to a deviant dot position in an image, both possibly leading to a deviant optical density, in dependence on a movement of the print element relative to the substrate receiving the marking material. Both deviations lead to a reduction of print quality. The amount of crosstalk depends on the design and configuration of the array of print elements, as well as the mutual distance between the elements and a relation between the actuation signal and a resonance frequency within the array.

It is known to reduce the influence of neighboring print elements by starting an actuation signal in a print element with a small delay in time, relative to the actuation signal of a neighboring print element. Although this delay also leads to a slightly different position of the associated ink dot on the substrate, this deviation is generally smaller than the one caused by the ink drop velocity deviance. In the printing of an image, a further print element may or may not be actuated, depending on the content of the image. Therefore, the crosstalk varies and a set of delay values is selected, each delay value associated with a print element in the array, to minimise the influence of possibly actuated neighboring print elements.

An example of a delay scheme that is used for the above-mentioned purpose is described in European Patent application EP 2662617. Herein an array of print elements is divided into groups, each group comprising a set of print elements that are actuated with a different delay, which is indicated by a phase relative to a synchronizing frequency for actuating the print elements, the groups being arranged consecutively in the array. Within a group, the respective phases increase up to a maximum and then decrease down to a minimum value, no phase value being equal to another. This may be embodied in a five print elements group by a series of associated phase values, in a range from 0 to 1, of respectively 0, ⅖, ⅘, ⅗, ⅕. With a frequency of 50 kHz, corresponding to a period of 20 μs, these phase values correspond to delay times of 0, 8, 16, 12, 4 μs.

However, this known scheme does not satisfy in all circumstances. In particular, print artefacts are found when combining more than one array, employing a similar scheme of delay values. Thus, a problem exists in using multiple arrays of piezo-electric inkjet print elements, wherein crosstalk within each of the arrays is minimized by a series of delay values, without deteriorating an overall print quality. An object of the present invention is to improve this situation.

### SUMMARY OF THE INVENTION

the predetermined delay values being based on a measurement of a drop velocity in dependence on a further, simultaneous actuation of a neighboring print element and forming a repetitive series of delay values for reducing an amount of mechanical crosstalk between the print elements in an array,

In order to achieve this object, the method according to the invention comprises the use of a predetermined, repetitive series of delay values associated with the print elements of an array for reducing an amount of mechanical crosstalk between the print elements in an array, the predetermined delay values being based on a measurement of a drop velocity in dependence on a further, simultaneous actuation of a neighboring print element, wherein two print elements that produce a drop of marking material for landing in each others vicinity on the substrate are associated with a different delay value of the repetitive series.

In a print process, print elements of various arrays and various print elements of the same array may contribute ink dots around a position on a substrate for reproducing an image in dependence on a configuration of print heads comprising the arrays and on a print strategy according to which the print heads are moved over the substrate. If these print elements are actuated with a similar delay value, the elements enhance a residual position deviation that results from the delay. In particular, the repetition length, which is the distance between print elements in a single array with the same delay value, may match a region of enhanced perceptual sensitivity, leading to a visible density modulation in a print. Using different delay values for print elements that produce drops landing around a position on the substrate, avoids the appearance of this modulation. The repetitive series of delay values is based on a measurement of a drop velocity in dependence on a further, simultaneous actuation of a neighboring print element. The drop velocity of an ejected ink drop is expected to be constant and the timing of an actuation of a print element is based on this constant value. However, it is known that a simultaneous actuation of a neighboring print element causes a deviation in the velocity and the volume of a drop. Measuring this deviation as a function of a small delay time between the two actuations enables a determination of a compensation scheme in the form of a repetitive series of delay values for arbitrary sets of actuation signals as used in an image.

In a further embodiment, the two print elements are each in a different array of the at least two arrays. In a usual arrangement of arrays, two arrays are laterally shifted in order to double the density of available print elements. Without precautions, a similar value of the repetitive series of delay values may easily be associated with nearby print elements, leading to the above-mentioned visible density modulation.

In a further embodiment, the at least two arrays are part of two different print heads mounted on a single carriage. Two print heads of the same type are commonly positioned accurately within one single carriage that is reciprocated over the substrate. In this way a double amount of ink may be applied to the substrate. However, print elements that apply ink drops that land in each others vicinity should not be printed with the same delay value. Thus, the repetitive series of delay values that are associated to the print elements within one print head are tuned with the delay values associated to the print elements within another print head.

In another embodiment, the two print elements are part of a single array that passes the same part of the substrate two times. Several print strategies exist that define a way wherein a print head moves over the substrate in two dimensions. If two print elements of the same array apply ink around a single position of the substrate, the repetitive series of delay values is set to avoid using the same value for these two elements.

In a further embodiment, a delay value of the repetitive series of delay values is a multiple of a time step. A further reduction of possible compensation schemes applies a discrete time step and its multiples, or a subset of its multiples, to select an optimal one.

In a further embodiment, the time step is based on a channel resonance frequency. This frequency is apparent from the relation between delay values and drop velocity deviation, also known as cross-talk relation. A delay value based on this time step keeps the velocity deviation as small as possible.

Further details of the invention are given in the dependent claims. The present invention may also be embodied in a print system for applying marking material to a substrate in order to reproduce an image, wherein one of the above-mentioned methods or a combination of these is applied for improving a quality of the printed image.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a configuration of arrays and print heads as used in the invention;

FIG. 2 is a schematic drawing of an ink dot jetted onto a substrate;

FIG. 3 shows a graph of two applied signals, one being delayed; and

FIG. 4 shows a relation between an amount of cross-talk and a delay time between the actuation of neighboring print elements.

### DETAILED DESCRIPTION OF EMBODIMENTS

The present invention will now be described with reference to the accompanying drawings, wherein the same or similar elements are identified with the same reference numeral. The skilled person will recognise that other embodiments are possible within the scope of the appended claims.

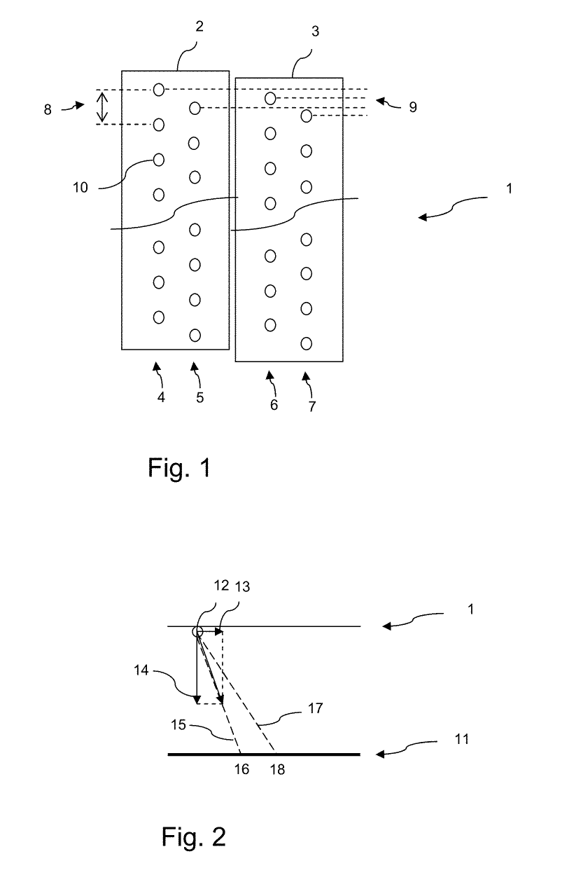

FIG. 1 shows a configuration 1 of two print heads 2 and 3, each print head comprising two arrays of print elements, respectively 4, 5 and 6, 7. A print element 10 is indicated by its opening towards the substrate. From this opening, also known as nozzle, the ink is applied. The print element further comprises a piezo-electric actuator that is in connection with an ink chamber. These are not further shown in detail. The configuration is viewed from the side where the ink leaves the print head, also called the nozzle plate. Each array comprises 128 nozzles, each print head comprises two arrays. The two print heads are accurately positioned in a carriage that is reciprocated over the substrate in order to print an image. The distance 8 between two print elements in an array is in this configuration 1/75 inch, or 340 μm. The distances between elements of different arrays is indicated by lines 9. This configuration is able to apply ink dots in lines that are 1/300 inch apart, or 84.5 μm. Images with 600 lines per inch are thus printed by two passes of the carriage.

FIG. 2 shows the application of a single ink drop 12 from a nozzle of a print element 10 in a nozzle plate of carriage configuration 1. The carriage has a forward velocity 13 and the ink drop is vertically jetted with velocity 14. This results in a drop trajectory 15 and an ink dot on the substrate 11 at position 16. If the velocity of the ink drop is smaller, for example due to cross-talk from a simultaneously jetted drop by a neighboring print element, a trajectory 17 may result and the ink dot will appear on position 18, well apart from the intended location 16. Thus, it is important that the velocity of the jetted ink drops is constant.

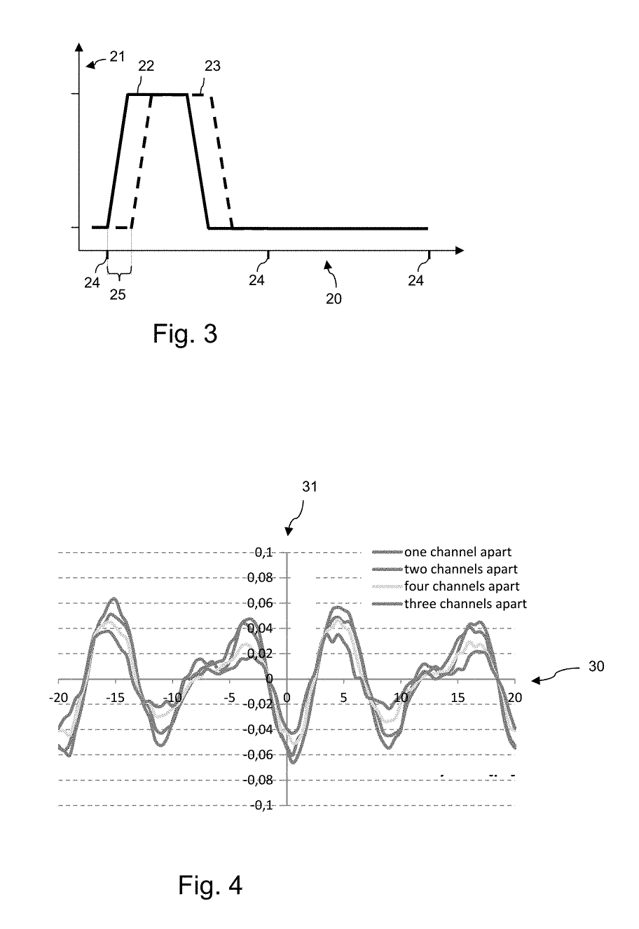

FIG. 3 shows an actuation signal in a time 20, voltage 21 graph. A first signal 22 is applied without delay relative to the trigger moments 24 that indicate a timing for a new print position on the substrate. The shape of the signal is such that the piezo-electric actuator is controlled to expand the ink chamber of the corresponding print element, to stabilize the expansion and then to contract the ink chamber, but a different shape is also possible, as long as the signal fits into the time span between two trigger moments. Depending on the size of the expansion, the contraction and the timing of the signal, an ink drop is generated by the print element. A second signal 23 is applied to a neighboring print element with a delay 25 relative to the trigger moments and the first signal 22. The first and second signal are not necessarily exactly the same, since the signals may be generated by different electric sources and may be tuned to the specific properties of the print element. Still, a delay value specifies a start of the expansion part of the signal relative to a trigger moment for a line of print positions. In the investigated embodiment of the invention, the time between the trigger moments is 20 microseconds.

FIG. 4 shows the influence of a delay 30 (in microseconds) between two signals for neighboring print elements within one array. This influence 31 is given as a relative change of drop velocity, which is nominal 4 m/s. It can be seen that not only directly neighboring, but also further neighboring print elements within a single array affect the velocity of an ink drop. A crucial aspect is that for a number of delay time values, the influence is close to zero, which means that the velocity of an ink drop is the same whether or not a neighboring print element is fired to generate an ink drop

Based on this finding, a series of delay values has been determined that is applied repetitively to the print elements of an array. Different series are possible. In the present embodiment, a series with a repetition length of 8 print elements has been applied.

TABLE 1
A repetitive series of delay values to be applied in a single array.

| | A | B | C | D | E | F | G | H |
|---|---|---|---|---|---|---|---|---|
| delay time (μs) | 0.0 | 2.5 | 17.5 | 10.0 | 5.0 | 15.0 | 12.5 | 7.5 |

The delay times respectively associated with print elements of an array can be indicated as ABCDEFGHABCDEFGHA . . . . Although it is not essential that the delay values are an integer times a discrete time step, as in this case each value is a integer multiple of 2.5 μs, it reduces the number of combinations that need to be considered. The value of the discrete time step is based on a channel resonance frequency as derived from the zero-crossings in FIG. 4.

For a combination of four arrays as shown in FIG. 1, in a print mode that applies a two-pass strategy, a delay order as indicated in Table 2 arises.

TABLE 2
Delay values associated with respective
print elements in a configuration of print heads,
each print head having two arrays in a two-pass strategy.
The numbering of print elements is per array.

| print line | pass | print head | array | print element | delay |
|---|---|---|---|---|---|
| 1 | 1 | 1 | 1 | 1 | A |
| 2 | 2 | 1 | 1 | 65 | A |
| 3 | 1 | 2 | 1 | 1 | A |
| 4 | 2 | 2 | 1 | 65 | A |
| 5 | 1 | 1 | 2 | 1 | A |
| 6 | 2 | 1 | 2 | 65 | A |
| 7 | 1 | 2 | 2 | 1 | A |
| 8 | 2 | 2 | 2 | 65 | A |
| 9 | 1 | 1 | 1 | 2 | B |
| 10 | 2 | 1 | 1 | 66 | B |
| 11 | 1 | 2 | 1 | 2 | B |
| 12 | 2 | 2 | 1 | 66 | B |
| 13 | 1 | 1 | 2 | 2 | B |
| 14 | 2 | 1 | 2 | 66 | B |
| 15 | 1 | 2 | 2 | 2 | B |
| 16 | 2 | 2 | 2 | 66 | B |
| 17 | 1 | 1 | 1 | 3 | C |
| . . . | . . . | . . . | . . . | . . . | . . . |

The density of the print lines is 600 lines per inch. As is apparent from the table, the odd print lines are printed in a first pass, the even print lines are printed in a second pass of the carriage over the substrate. Eight neigbouring print lines are printed with the same delay value, which leads to visible defects, in dependence on the image that is printed.

According to an embodiment of the invention, the order of delay values is mixed over the various arrays of the print heads and passes, such that two print lines, each printed by a corresponding print element, that are in each others vicinity on the substrate, are associated with a different delay value of the repetitive series of delay values.

TABLE 3
Delay values associated with respective print elements in the same
application as in Table 2, but here a mixed order.

| print line | pass | print head | array | print element | delay |
|---|---|---|---|---|---|
| 1 | 1 | 1 | 1 | 1 | A |
| 2 | 2 | 1 | 1 | 65 | B |
| 3 | 1 | 2 | 1 | 1 | C |
| 4 | 2 | 2 | 1 | 65 | D |
| 5 | 1 | 1 | 2 | 1 | E |
| 6 | 2 | 1 | 2 | 65 | F |
| 7 | 1 | 2 | 2 | 1 | G |
| 8 | 2 | 2 | 2 | 65 | H |
| 9 | 1 | 1 | 1 | 2 | B |
| 10 | 2 | 1 | 1 | 66 | C |
| 11 | 1 | 2 | 1 | 2 | D |
| 12 | 2 | 2 | 1 | 66 | E |
| 13 | 1 | 1 | 2 | 2 | F |
| 14 | 2 | 1 | 2 | 66 | G |
| 15 | 1 | 2 | 2 | 2 | H |
| 16 | 2 | 2 | 2 | 66 | A |
| 17 | 1 | 1 | 1 | 3 | C |
| 18 | 2 | 1 | 1 | 67 | D |
| 19 | 1 | 2 | 1 | 3 | E |
| 20 | 2 | 2 | 1 | 67 | F |
| 21 | 1 | 1 | 2 | 3 | G |
| 22 | 2 | 1 | 2 | 67 | H |
| 23 | 1 | 2 | 2 | 3 | A |
| 24 | 2 | 2 | 2 | 67 | B |
| 25 | 1 | 1 | 1 | 4 | D |
| . . . | . . . | . . . | . . . | . . . | . . . |

An example of this mixing is shown in Table 3. Within each array, the same order of delay times as given in Table 1 is applied. Using the delay values of Table 3, no systematic density variation is observed, thus improving the resulting print quality.

Other print strategies may require a different series of delay values and a different order of mixing, as long as print elements that produce drops of ink landing in each others vicinity are associated with a different delay value.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A method for applying marking material to a substrate in order to reproduce an image by at least two arrays of at least two print elements in each array, a print element comprising a piezo-electric actuation element for generating a drop of marking material, an actuation signal for a print element being applied with a predetermined delay with respect to a reference actuation signal, the predetermined delay values being based on a measurement of a drop velocity in dependence on a further, simultaneous actuation of a neighboring print element and forming a repetitive series of delay values for reducing an amount of mechanical crosstalk between the print elements in an array, wherein two print elements that produce a drop of marking material for landing in each others vicinity on the substrate are associated with a different delay value of the repetitive series of delay values.

2. The method according to claim 1, wherein the two print elements are each in a different array of the at least two arrays.

3. The method according to claim 2, wherein the at least two arrays are part of two different print heads mounted on a single carriage.

4. The method according to claim 1, wherein the two print elements are part of a single array that passes the same part of the substrate two times.

5. The method according to claim 1, wherein a delay value of the repetitive series of delay values is a multiple of a time step.

6. The method according to claim 5, wherein the time step is based on a channel resonance frequency.

7. A print system for applying marking material to a substrate in order to reproduce an image, wherein a method according to claim 1 is applied for improving a quality of the printed image.
